(19) United States
(12) Patent Application Publication
(10) Pub. No.: US 2013/0155914 A1
(43) Pub. Date: Jun. 20, 2013

(54) RESOURCE ALLOCATION FOR PUCCH FORMAT 1B WITH CHANNEL SELECTION IN AN LTE-A TDD SYSTEM

(71) Applicants: Ping Wang, Beijing (CN); Debdeep Chatterjee, Santa Clara, CA (US); Jong-Kae Fwu, Sunnyvale, CA (US)

(72) Inventors: Ping Wang, Beijing (CN); Debdeep Chatterjee, Santa Clara, CA (US); Jong-Kae Fwu, Sunnyvale, CA (US)

(21) Appl. No.: 13/572,099

(22) Filed: Aug. 10, 2012

(30) Foreign Application Priority Data
Dec. 20, 2011 (US) PCT/US11/66312

(51) Int. Cl. H04W 72/04; H04J 3/00

(52) U.S. Cl. 370/280; 370/329

(57) ABSTRACT

Embodiments of methods and apparatus for resource allocation for physical uplink control channels are described herein. Other embodiments may be described and claimed.

### CLAIM OF PRIORITY

The present application claims priority to Patent Cooperation Treaty International Application No. PCT/US2011/066312, filed in the United States Receiving Office on Dec. 20, 2011, which claims priority to U.S. Provisional Application 61/430,879 titled “Advanced Wireless Communication Systems and Techniques” filed Jan. 7, 2011, which is incorporated by reference in its entirety.

### BACKGROUND ART

There is a constant need to provide telecommunication services to fixed and mobile subscribers as efficient and inexpensively as possible. Further, the increased use of mobile applications has driven development of wireless systems that are capable of delivering large amounts of data at high speed. Development of more efficient and higher bandwidth wireless networks has become increasingly important and addressing issues of how to maximize efficiencies in such networks is ongoing.

### BRIEF DESCRIPTION OF THE DRAWING

Aspects, features and advantages of embodiments of the present invention will become apparent from the following description of the invention in reference to the appended drawings in which like numerals denote like elements and in which:

FIG. 1 is block diagram of an example wireless network according to various embodiments;

FIG. 2 is a flow diagram showing an exemplary method for resource allocation according to various embodiments;

FIG. 3 is a diagram showing an example of resource allocation according to various embodiments;

FIG. 4 is a diagram showing an example of resource allocation according to various embodiments;

FIG. 5 is a diagram showing an example of resource allocation according to various embodiments;

FIG. 6 is a diagram showing an example of resource allocation according to various embodiments;

FIG. 7 is a diagram showing an example of resource allocation according to various embodiments;

FIG. 8 is a diagram showing an example of resource allocation according to various embodiments;

FIG. 9 is a diagram showing an example of resource allocation according to various embodiments;

FIG. 10 is a diagram showing an example of resource allocation according to various embodiments; and

FIG. 11 is a block diagram showing an example wireless system arranged to communicate in a wireless network.

### DETAILED DESCRIPTION OF THE INVENTION

While the following detailed description describes example embodiments of the present invention in relation to broadband wireless wide area networks (WWANs), the invention is not limited thereto and can be applied to other types of wireless networks where similar advantages can be obtained. Such networks specifically include, if applicable, wireless local area networks (WLANs), wireless personal area networks (WPANs) and/or wireless metropolitan area networks (WMANs). Further, while specific embodiments may be described in reference to wireless networks utilizing orthogonal frequency division multiplexing (OFDM) or orthogonal frequency division multiple access (OFDMA), the embodiments of present invention are not limited thereto and, for example, can be implemented and/or combined with other air interfaces including single carrier communication channels including single-carrier frequency division multiple access (SC-FDMA) or other protocols and air interfaces for uplink (UL) and downlink (DL) communications where suitably applicable.

The following inventive embodiments can be used in a variety of applications including transmitters and receivers of a radio system, although embodiments of the invention are not limited in this respect. Radio systems specifically included within the scope of the present invention include, but are not limited to, fixed or mobile devices, relays, gateways, bridges, hubs, routers, network interface cards (NICs), network adaptors, or other network devices. Further, the radio systems may be implemented in cellular radiotelephone systems, satellite systems, two-way radio systems as well as computing devices including such radio systems including personal computers (PCs), netbooks, tablets, and related peripherals, personal digital assistants (PDAs), personal computing accessories, hand-held communication devices such as smartphones and all systems which may be related in nature and to which the principles of the inventive embodiments could be suitably applied. Further, each system can be arranged to operate using a number of radios heterogeneously over a plurality of networks wherein two or more networks overlap and co-exist, such as a WWAN, a WLAN, and/or a WPAN.

For the purposes of the detailed description, the phrase “A/B” means A or B. The phrase “A and/or B” means “(A), (B), or (A and B).” The phrase “at least one of A, B and C” means “(A), (B), (C), (A and B), (A and C), (B and C) or (A, B and C).” Also, the phrase “(A)B” means “(B) or (AB),” that is, A is an optional element.

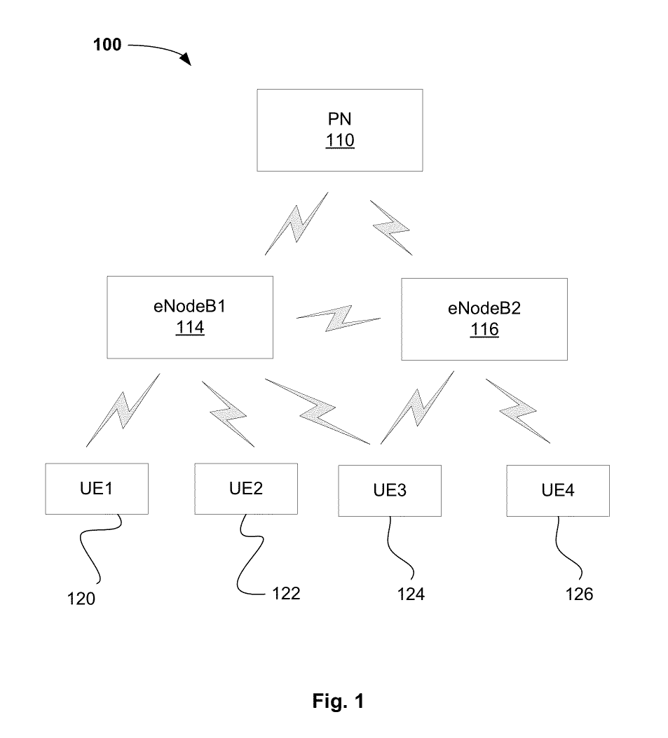

Turning to FIG. 1, an example wireless communication network 100 according to various inventive embodiments may be any wireless system capable of facilitating wireless access between a core network or provider network (PN) (110), one or more evolved node B (eNodeB) 114 and 116, and one or more user equipment (UE) 120-126 including mobile and/or fixed subscribers. In various embodiments, the eNodeB 114 and/or 116 may be a fixed station (e.g., a fixed node) or a mobile station/node. In alternate embodiments, relay nodes (not shown) may also be in communication with one or more of the UE 120-126 and/or a donor eNodeB. Further, a number of the UE 120-126 may also be in communication with one or more other wireless networks 100 including different types of wireless networks through heterogeneous networking (not shown).

Network 100 can be a wireless communication network such as those contemplated by a 3^{rd} Generation Partnership Project (3GPP) Long Term Evolution (LTE) mobile phone network and its evolution LTE-Advanced (LTE-A), an Institute for Electrical and Electronics Engineers (IEEE) 802.16 mobile broadband wireless access (BWA) network, an IEEE 802.11 WLAN, or other type of network to which the principles of the inventive embodiments could be suitably applied. As used herein, the term “LTE-A” refers to any past, present, or future LTE standard, including, but not limited to, the version 10 edition.

Reference herein to a user equipment (UE) may be a platform such as a subscriber station (SS), station (STA), terminal, mobile station (MS), advanced mobile station (AMS), high throughput (HT) station (STA), or very HT STA (VHT STA), among others. The various forms of platform including the UE, terminal, SS, MS, HT STA, and VHT STA may be interchanged and reference to a particular platform does not preclude other platforms from being substituted in various embodiment(s). An eNodeB may be a base station (BS), advanced base station (ABS), access point (AP), node, or node B. Further, these terms may be conceptually interchanged, depending on which wireless protocol is being employed, so a reference to eNodeB herein may also be seen as a reference to a BS, ABS, or AP, in various embodiments.

The UE 120-126 and/or the eNodeB 114 and/or 116 may include a plurality of antennas to implement a multiple-input-multiple-output (MIMO) transmission system, which may operate in a variety of MIMO modes, including single-user MIMO (SU-MIMO), multi-user MIMO (MU-MIMO), close loop MIMO, open loop MIMO or variations of smart antenna processing. Also, each UE 120-126 and/or eNodeB 114 and/or 116 may be configured with a plurality of input antennas and a single output antenna (MISO) or a single input antenna and a plurality of output antennas (SIMO).

The UE 120-126 may provide some type of channel state information (CSI) feedback to one or more of the eNodeB 114 and/or 116 via one or more up link channels, and the eNodeB 114 and/or 116 may adjust one or more DL channels based on the received CSI feedback. The feedback accuracy of the CSI may affect the performance of the MIMO system. The CSI feedback may include information related to channel quality index (CQI), precoding matrix indicator (PMI), and rank indication (RI). PMI may reference, or otherwise uniquely identity a precoder within a codebook. The eNodeB 114 and/or 116 may adjust the DL channel based on the precoder referenced by the PMI.

The UL channels and the DL channels can be associated with one or more frequency bands, which may or may not be shared between the UL channels and the DL channels. In one embodiment, the UL channels are positioned in a first frequency band and the DL channels are positioned in a second frequency band in a frequency division duplex (FDD) configuration. In another embodiment, the UL channels and the DL channels are positioned in a common frequency band in a time division duplex (TDD) configuration. Further, each frequency band may or may not be a contiguous frequency band. Each frequency band may be further divided into one or more subbands, which may or may not be shared by the UL and DL channels. Each frequency subband, carrier, or subcarrier, one or more aggregated subbands, or the one or more frequency bands for the UL or DL channels (wideband) may be referred to as a frequency resource.

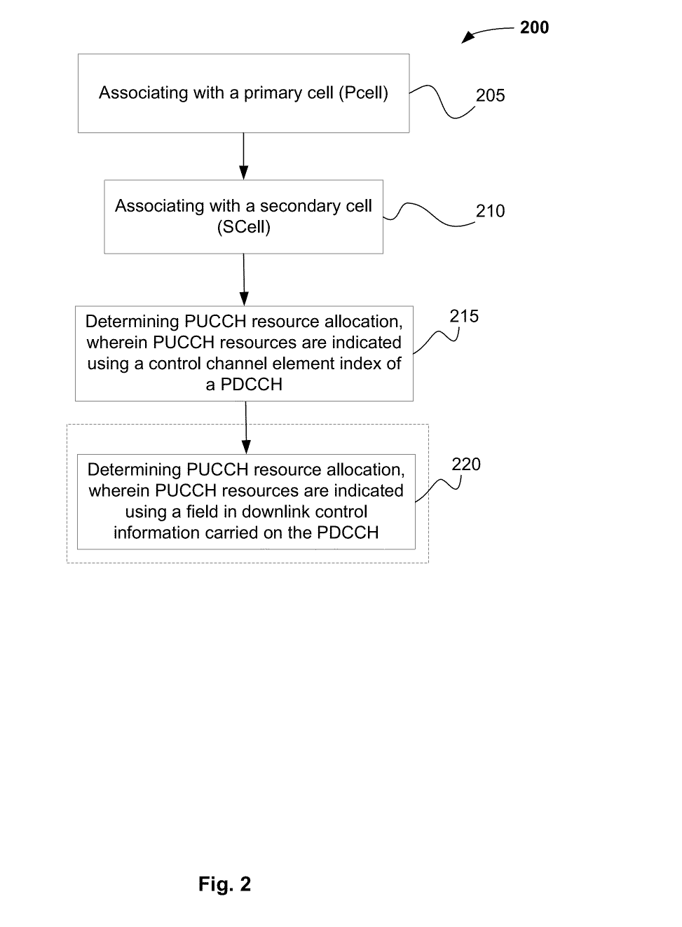

FIG. 2 illustrates an exemplary embodiment of a method to allocate physical uplink control channel (PUCCH) resources, such as physical resource blocks (PRB) and modulation and coding schemes (MCS), using PUCCH format 1b with channel selection for feedback of hybrid automatic repeat request (HARQ) acknowledgement (ACK)/negative acknowledgement (NACK) information in time division duplex (TDD) systems supporting carrier aggregation over multiple carriers for a plurality of serving cells. Serving cells can include a primary cell (PCell) and a secondary cell (SCell), though the embodiments are not so limited and may also comprise one or more additional serving cells. For example, additional SCells may be added in other embodiments.

TDD systems may also be arranged to operate using frequency division duplexing (FDD), or co-exist with systems arranged to operate using FDD. The TDD system may be a 3GPP LTE or LTE-A system supporting carrier aggregation over two carriers or another wireless system arranged for TDD communication using two or more carriers. When using PUCCH format 1b with channel selection, four (4) or fewer bits of information may be transmitted using channel selection from amongst four unique PUCCH resources, each capable of carrying two (2) bits.

For LTE and LTE-A devices such as the UE 120-126 and/or the eNodeB 114 and/or 116 arranged to communicate using TDD, the HARQ ACK/NACK information corresponding to a number of subframes for the PCell and SCell is communicated by the UE to the eNodeB in an UL subframe according to a downlink association set. One such downlink association set index K: {k_{0,} k_{1,} . . . k_{M-1}} for TDD is illustrated in Table 1.

TABLE 1

| UL-DL | Subframe n | | | | | | | | | |
|---|---|---|---|---|---|---|---|---|---|---|
| Configuration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, 4, 6 | — | — | — | — | 8, 7, 4, 6 | — | — |
| 3 | — | — | 7, 6, 11 | 6, 5 | 5, 4 | — | — | — | — | — |
| 4 | — | — | 12, 8, 7, 11 | 6, 5, 4, 7 | — | — | — | — | — | — |
| 5 | — | — | 13, 12, 9, 8, 7, 5, 4, 11, 6 | — | — | — | — | — | — | — |
| 6 | — | — | 7 | 7 | 5 | — | — | 7 | 7 | — |

As an example of how the downlink association set index of Table 1 is used, for UL-DL configuration 1, subframe 2 (where n=2, which is an UL subframe that can be used to transmit HARQ ACK/NACK information using a PUCCH), corresponding DL data previously transmitted over a physical downlink shared channel (PDSCH) and scheduled by an associated physical downlink control channel (PDCCH), wherein the corresponding DL data was transmitted in n−k subframe(s) (k=7 or 6 in this example having two elements) will have its ACK/NACK transmitted in subframe n (n=2 in this example). Considering there are 10 subframes per frame in these embodiments, for k=7, n−k=2+10 (from previous frame)−7=5. For k=6, k=2+10 (from previous frame)−6=6. So, for UL-DL configuration 1, the PDSCH transmitted in subframe 5 and 6 of a previous frame will be ACK'd/NACK'd in subframe 2 of a following frame. In this example, subframe n=2 is an UL subframe for all configurations. In another example, UL-DL configuration 4, subframe 3 is another UL subframe having four elements.

Embodiments of the invention provide resource allocation in an UL subframe when M=2, M=3, or M=4, where M is the cardinality of the set K of elements, such as the elements of Table 1. In UL-DL configuration 1, subframe 2, M=2 because there are two elements. M may also be identified as a bundling window size for time-domain (i.e. subframe) bundling.

Resource allocation for a channel may be made implicitly and/or explicitly. Implicit resource allocation can occur when intended resource allocations are inferred through the transfer of information that is sent for an alternate purpose. Use of implicit resource allocation allows for more information to be transferred without use of additional resources, thereby providing a more efficient signaling process. Explicit resource allocation can occur when intended resource allocations are signaled using resources designated for the transfer of resource allocation.

Resource allocation signaling for UL transmission(s), made through transmission of DL subframes, can be indicated, sensed, or determined efficiently using implicit signaling to reduce bits that would have otherwise been transmitted in DL frame(s) or subframe(s), thereby improving power consumption, throughput, and latency, among other performance criteria. Further, resource allocation signaling for UL transmission(s), made through transmission of DL subframes, can be indicated explicitly using existing subframe field(s) transmitted in the DL to simplify DL subframe format(s) and to provide for improved compatibility.

In embodiments, resource allocation information for PUCCH format 1b with channel selection is carried by the PDCCH. In LTE or LTE-A, modulation for the PUCCH format 1b with channel selection is performed using quadrature phase shift key (QPSK) with two bits. Alternate modulation schemes and/or number of bits may be used in other embodiments.

Referring to FIG. 2, an exemplary method 200 for communicating in a wireless communication network 100 can include associating a UE, such as UE3 124, with an eNodeB, such as eNodeB1 114, in a primary cell (PCell) in element 205. Association of the UE with the eNodeB can include a cell search procedure wherein the UE acquires time and frequency synchronization with the PCell and detects a physical layer cell identification (ID) of the PCell. The cell search procedure may include transmitting, in a DL transmission, primary and secondary synchronization signals to the UE from the eNodeB. In element 210, the UE associates with an eNodeB, such as eNodeB2 116, in a secondary cell (SCell) wherein the UE can associate with the SCell after receiving an activation command.

The UE can determine all or at least a portion of the UE's PUCCH resource allocation in element 215. For a PDSCH transmission made over a plurality of subframes sent on a PCell and/or SCell, where the transmission is indicated by detection of a corresponding PDCCH on the PCell, a number of PUCCH resources can be indicated implicitly using an appropriate function of the lowest, or first, control channel element (CCE) index (n_{CCE}) or (n_{CCE,m}), used for transmission of a downlink control information (DCI) assignment, of the corresponding PDCCH. A control channel element index, in the context of 3GPP LTE or LTE-A, is a set of resource elements where part or all of a PDCCH message can be mapped. There may be 36 resource elements in the set, though additional or fewer resource elements may be used in other embodiments.

A number of PUCCH resources may also be indicated in element 220. For a PDSCH transmission on a SCell indicated by detection of a corresponding PDCCH on the SCell, one or more PUCCH resources may be indicated explicitly by re-using a transmit power control (TPC) field in DCI of the corresponding PDCCH to indicate one or more of the up to four PUCCH resource values, wherein the number of PUCCH resources or PUCCH resource values are configured by higher layers, which may include a medium access control (MAC) layer, radio link control (RLC) layer, and/or packet data convergence protocol (PDCP) layer, such as through radio resource control (RRC) signaling. The DCI can be transferred over layer 1/layer 2 (L1/L2) control channels, wherein the L1/L2 control channels provide the UE, such as the UE 124, with necessary information for reception and decoding of DL data, and for UL control information used to provide a scheduler and HARQ protocol along with information about the UE. Additional or substitute fields, other than the TPC field, may be used to indicate a number of PUCCH resources in alternate embodiments.

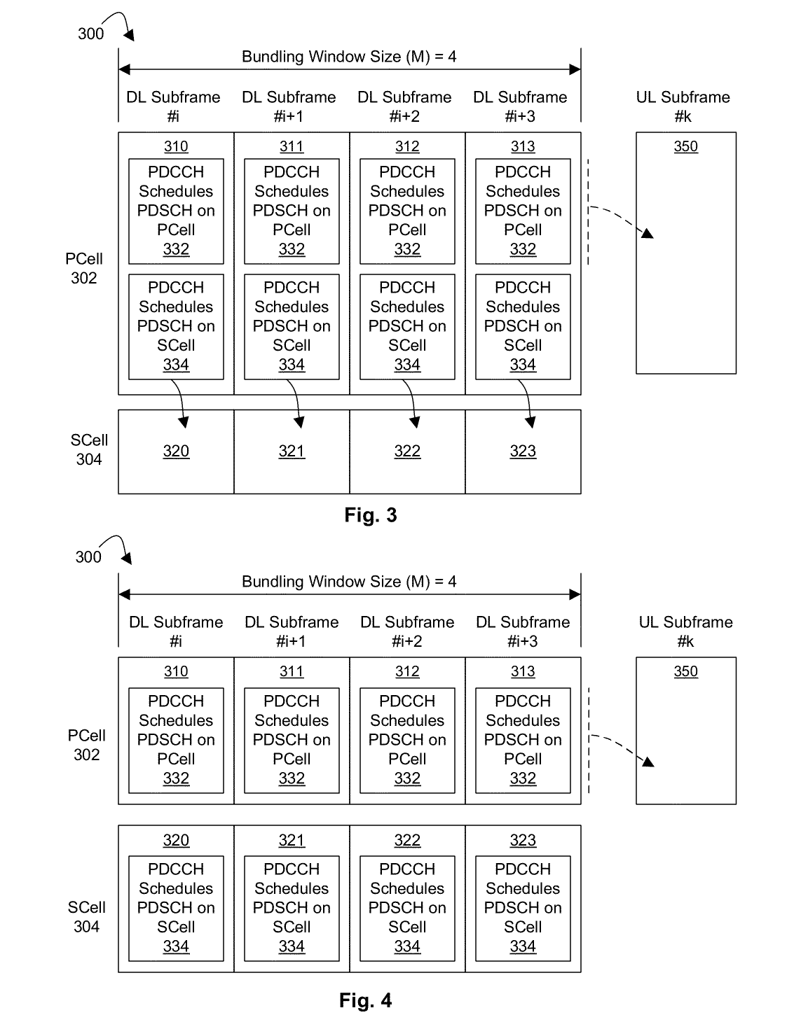

FIG. 3 is a diagram showing an example of PUCCH resource allocation according to various embodiments. A primary cell (PCell) 302 and a secondary cell (SCell) 304, which may be deployed respectively by the eNodeB1 114 and the eNodeB2 116 of FIG. 1, and a plurality of subframes having a subframe bundling window size (M) equal to 4 in a bundling window 300 may be transmitted in the PCell 302 and the SCell 304. More or fewer subframes may be used in each bundling window in alternate embodiments. The bundling window 300 of the PCell 302 comprises DL subframes 310-313 and the SCell 304 comprises subframes 320-323. The PCell 302 and the SCell 304 each employ one or more component carriers (CC) which may be 1.4, 3, 5, 10, or 20 megahertz (MHz) in bandwidth. Each CC may be contiguous or non-contiguous.

In FIG. 3, up to two CCs are used on the DL to transmit scheduling information in each DL subframe using a PDCCH to schedule a PDSCH on the PCell 332 and to transmit scheduling information using the PDCCHs to schedule PDSCH on the SCell 334, wherein four PUCCH resources are implicitly scheduled on the UL in one or more UL subframes 350. The PDCCH, PDSCH, and the PUCCH are physical channels wherein each physical channel corresponds to a set of resource elements in a time-frequency grid for the transport of information and/or data.

The PDCCH can carry information such as transport format and resource allocation related to the DL-SCH and paging channel (PCH) transport channels as well as related HARQ information. The PDSCH is a DL channel that can carry user data and other signaling information while the PUCCH can carry UL control information including channel quality indicators (CQI), acknowledgement (ACK) and negative acknowledgement (NAK) for HARQ in response to DL transmission and UL scheduling requests.

In embodiments, the UL resource allocation illustrated in FIG. 3 applies to TDD HARQ-ACK multiplexing with PUCCH format 1b with channel selection for a bundling window 300 size equal to four, and two configured serving cells with cross-carrier scheduling. In the embodiment of FIG. 3, between two and four PUCCH resources can be derived resulting from transmissions in DL subframes of the bundling window 300 associated with the UL subframe 350 wherein each PUCCH resource can be indicated by transmission of a corresponding PDSCH transmission, e.g. a first PUCCH resource is indicated by a first PDSCH transmitted on the PCell 302 in the first downlink subframe 310, a second PUCCH resource is indicated by a second PDSCH transmitted on the PCell 302 in the second downlink subframe 311, and so on resulting in four PUCCH resources. Fewer PUCCH resources may be indicated in alternate embodiments.

FIG. 4 is an embodiment wherein the PDCCHs are transmitted on the PCell 302 and the SCell 304. The UL resource allocation illustrated in FIG. 4 applies to TDD HARQ-ACK multiplexing with PUCCH format 1b with channel selection for a bundling window 300 size equal to four, and two configured serving cells with no cross-carrier scheduling. Between two and four PUCCH resource allocations can be implicitly indicated for the UL. Each PUCCH resource may be indicated implicitly by transmission of a corresponding PDSCH transmission, e.g. a first PUCCH resource is indicated by a first PDSCH transmitted on the PCell 302, a second PUCCH resource is indicated by a second PDSCH transmitted on the PCell 302, and so on wherein each PUCCH resource may be indicated by a PDSCH transmitted on the PCell 302 and/or the SCell 304.

In FIGS. 3 and 4, PUCCH resources can be allocated using a lowest control channel element (CCE) index (N_{CCE}) of PDCCH transmitted on the PCell 302 to schedule the PDSCH on the PCell 302 and/or SCell 304 within four DL subframes, i.e. DL Subframe #i through DL Subframe #i+3, to implicitly indicate four PUCCH resources.

In other embodiments, a number of PUCCH resources may be implicitly indicated by the PDCCH(s) transmitted on the PCell to schedule PDSCH transmission(s) on the PCell 302, and a number of PUCCH resources may be implicitly indicated by the PDCCH(s) transmitted on the PCell to schedule PDSCH transmission(s) on the SCell 304 in embodiments with cross-carrier scheduling, or indicated by the PDCCH(s) transmitted on the SCell to schedule PDSCH transmission(s) on the SCell 304 in embodiments with no cross-carrier scheduling to indicate a total of four PUCCH resources for the UL subframe 350.

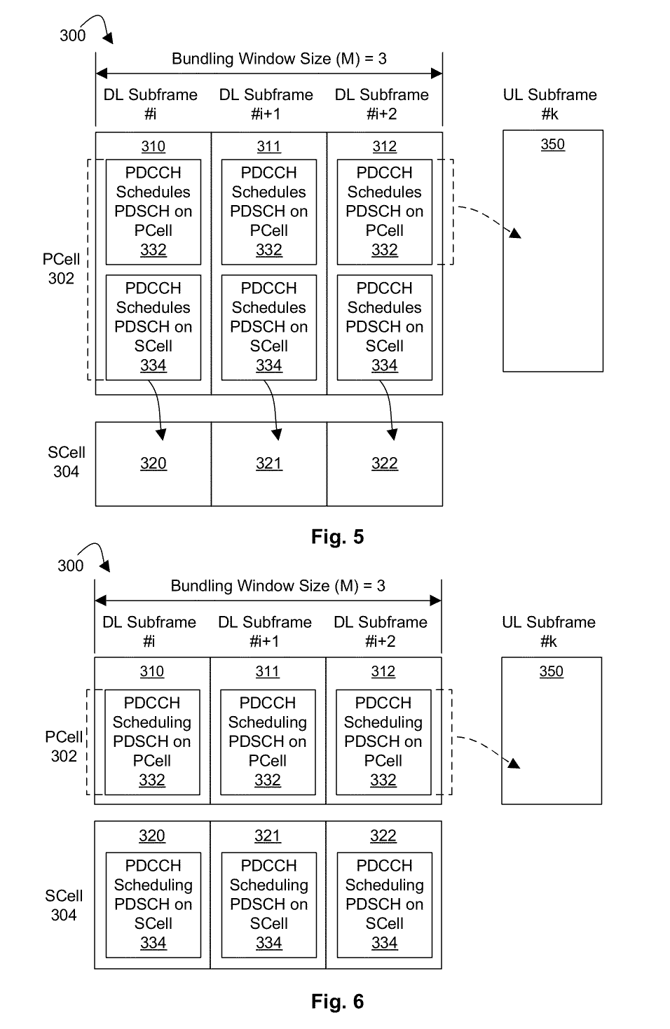

FIG. 5 illustrates UL resource allocation for TDD HARQ-ACK multiplexing with PUCCH format 1b with channel selection for a bundling window 300 size equal to three, and two configured serving cells with cross-carrier scheduling. Four PUCCH resources can be derived from transmissions in DL subframes of the bundling window 300 associated with the UL subframe 350. Fewer PUCCH resources can be indicated in alternate embodiments.

In FIG. 5, up to two DL component carriers can be used and all PDCCHs are transmitted on the DL PCell 302. The PDCCHs on the SCell 304 are scheduled by PDCCHs on the PCell 302 using cross carrier scheduling. Four PUCCH resource allocations are indicated for the UL subframe 350 in this embodiment. When resource allocation is provided using LTE-A TDD PUCCH format 1b with channel selection, the UL resources are allocated using a first or lowest CCE index (N_{CCE}) of PDCCH transmitted on the PCell 302 to schedule the PDSCH on the PCell 332 within three DL subframes to implicitly indicate three PUCCH resources. Further, the first or lowest CCE index (N_{CCE}) of any one PDCCH transmitted on the PCell 302 to schedule the PDSCH on the SCell 334 within 3 DL subframes can implicitly indicate one more PUCCH resource to provide a total of four UL resources.

FIG. 6 illustrates UL resource allocation for TDD HARQ-ACK multiplexing with PUCCH format 1b with channel selection for a bundling window 300 size equal to three, and two configured serving cells with no cross-carrier scheduling. Four PUCCH resources can be derived from transmissions in DL subframes of the bundling window 300 associated with the UL subframe 350. In this embodiment, the PDCCHs are transmitted on both the DL PCell 302 and the DL SCell 304 using independent scheduling. Further, the resources can be allocated using a lowest or first CCE index (N_{CCE}) of PDCCHs transmitted to schedule the PDSCH on the PCell 302 within three DL subframes to implicitly indicate three PUCCH resources. Also, using the next lowest N_{CCE}+1 of any one PDCCH transmitted to schedule the PDSCH on the PCell 302 within three DL subframes can implicitly indicate one more PUCCH resource.

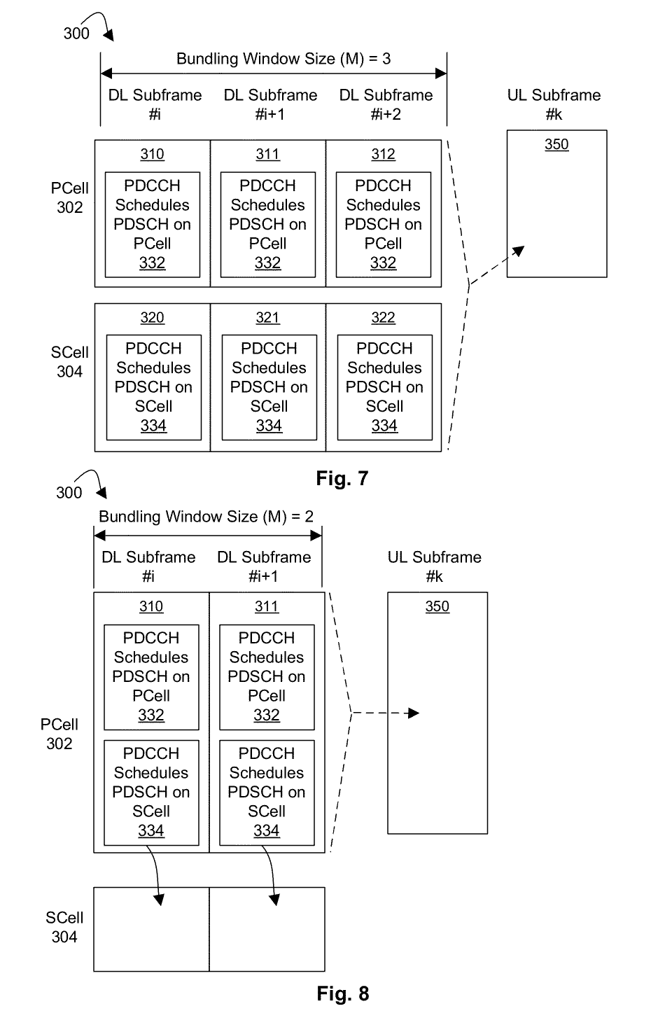

FIG. 7 illustrates UL resource allocation for TDD HARQ-ACK multiplexing with PUCCH format 1b with channel selection for a bundling window 300 size equal to three, and two configured serving cells with no cross-carrier scheduling. Four PUCCH resources are derived from transmissions in DL subframes of the bundling window 300 associated with the UL subframe 350. One or more PUCCH resources can be indicated implicitly by the PDCCH(s) transmitted on the PCell to schedule PDSCH transmission(s) on the PCell 302 and one or more PUCCH resources can be indicated via the PDCCH(s) transmitted on the SCell to schedule PDSCH transmission(s) on the SCell 304 to indicate a total of four PUCCH resources for the UL subframe 350. Each PUCCH resource may be indicated implicitly by transmission of a corresponding PDSCH transmission, e.g. a first PUCCH resource is indicated by a first PDSCH transmitted on the PCell 302, a second PUCCH resource is indicated by a second PDSCH transmitted on the PCell 302, and so on wherein each PUCCH resource may be indicated by a PDSCH transmitted on the PCell 302 and/or the SCell 304.

A field such as a transmit power control (TPC) field in the DCI format corresponding to a PDCCH in the DL SCell 304 within three DL subframes as the ACK/NAK resource indicator (ARI) bits may be used to explicitly indicate a PUCCH resource configured by higher layers such as through radio resource control (RRC) signaling. As a result, three PUCCH resources are implicitly indicated and one more PUCCH resource is explicitly indicated to indicate a total of four PUCCH resources for the UL subframe 350.

FIG. 8 illustrates UL resource allocation for TDD HARQ-ACK multiplexing with PUCCH format 1b with channel selection for a bundling window 300 size equal to two, and two configured serving cells with cross-carrier scheduling. A plurality of PUCCH resources can be derived from transmissions in DL subframes of the bundling window 300 associated with the UL subframe 350. The third bundling window 300 comprises a first DL subframe 310 and a second DL subframe 311 with two PDCCHs to schedule two PDSCHs on the PCell 332 and two PDCCHs to schedule two PDSCHs on the SCell 334 using cross-carrier scheduling for the SCell 304. In FIG. 8, three PUCCH resources can be implicitly indicated for the UL subframe 350 using the PDCCHs scheduling PDSCH transmissions on PCell 302 and SCell 334 for DL subframes 310 and 311. Additional PUCCH resources may be indicated either implicitly or explicitly in other embodiments.

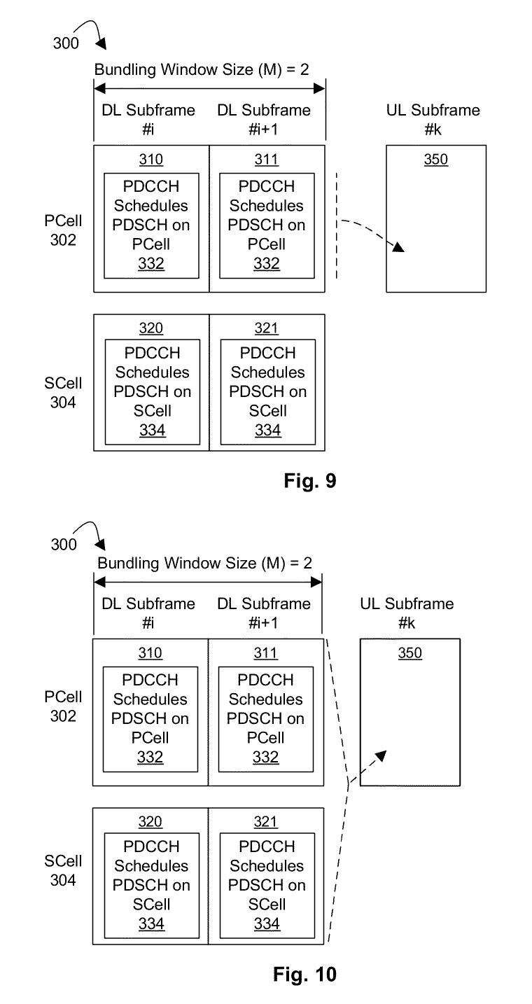

FIG. 9 illustrates UL resource allocation for TDD HARQ-ACK multiplexing with PUCCH format 1b with channel selection for a bundling window 300 size equal to two, and two configured serving cells with no cross-carrier scheduling. In an embodiment, three PUCCH resources can be derived from transmissions in DL subframes of the bundling window 300 associated with the UL subframe 350.

PUCCH resources can also be allocated using a first or lowest CCE index (N_{CCE}) of a PDCCH transmitted on the PCell 302 to schedule the PDSCH on the PCell 332, within two DL subframes, to implicitly indicate two PUCCH resources. Further, using the next lowest N_{CCE}+1 of any one PDCCH transmitted on the PCell 302 to schedule the PDSCH on the PCell 332 within two DL subframes can implicitly indicate one more PUCCH resource to indicate three PUCCH resources for the UL subframe 350. Additional PUCCH resources may be indicated either implicitly or explicitly in other embodiments.

FIG. 10 illustrates UL resource allocation for TDD HARQ-ACK multiplexing with PUCCH format 1b with channel selection for a bundling window 300 size equal to two, and two configured serving cells with no cross-carrier scheduling. Three PUCCH resources can be derived from transmissions in DL subframes of the bundling window 300 associated with the UL subframe 350. In this embodiment, a TPC field in the DCI corresponding to a PDCCH in the DL SCell 304 within two DL subframes as the ACK/NAK resource indicator (ARI) bits can be used to explicitly indicate an additional PUCCH resource for the UL subframe 350. In FIG. 10, two PUCCH resources are indicated implicitly by the PDCCH scheduling PDSCH on PCell 332, and an additional PUCCH resource is explicitly indicated by reusing TPC commands in PDCCH on SCell as the ARI to indicate a total of three PUCCH resources for the UL subframe 350. Additional PUCCH resources may be indicated either implicitly or explicitly in other embodiments.

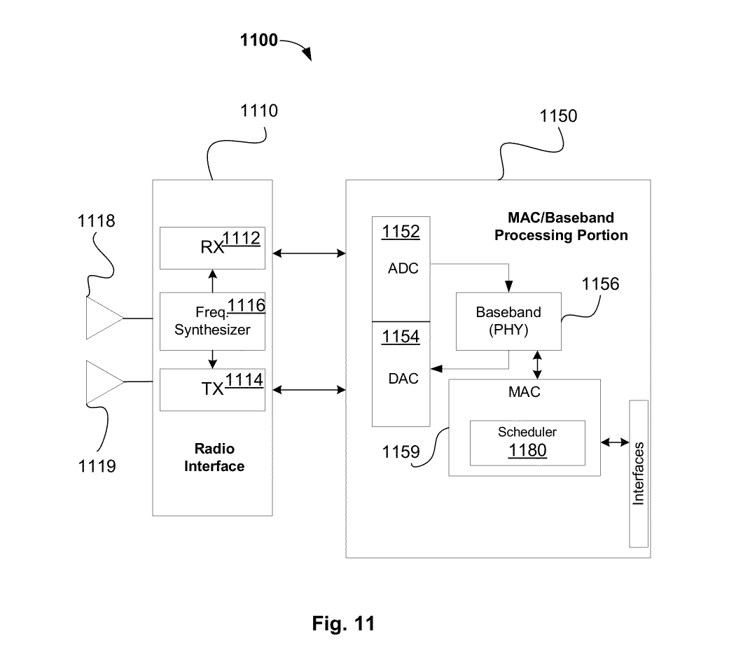

Referring to FIG. 11, an apparatus 1100 for use in a wireless communication network 100 may include a processing circuit 1150 including logic (e.g., circuitry, processor and software, or combination thereof) to perform abbreviated bandwidth requests/grants as described in one or more of the processes above. In certain non-limiting embodiments, apparatus 1100 may generally include a radio frequency (RF) interface 1110 and a medium access controller (MAC)/baseband processor portion 1150. Elements of FIG. 11 can be arranged to provide means to implement the operations and methods described herein.

In one example embodiment, RF interface 1110 may be any component or combination of components arranged to send and receive multi-carrier modulated signals although the inventive embodiments are not limited to any specific over-the-air (OTA) interface or modulation scheme. RF interface 1110 may include, for example, a receiver 1112, a transmitter 1114 and a frequency synthesizer 1116. Interface 1110 may also include bias controls, a crystal oscillator and/or one or more antennas 1118, 1119 if desired. Furthermore, RF interface 1110 may alternatively or additionally use external voltage-controlled oscillators (VCOs), surface acoustic wave filters, intermediate frequency (IF) filters and/or radio frequency (RF) filters as desired. Various RF interface designs and their operation are known in the art and an expansive description thereof is therefore omitted.

Processing portion 1150 may communicate with RF interface 1110 to process receive/transmit signals and may include, by way of example only, an analog-to-digital converter 1152 for down converting received signals, a digital-to-analog converter 1154 for up converting signals for transmission, and if desired, a baseband processor 1156 for physical (PHY) link layer processing of respective receive/transmit signals. Processing portion 1150 may also include or be comprised of a processing circuit 1159 for medium access control (MAC)/data link layer processing.

In certain embodiments, MAC processing circuit 1159 may include a scheduler 1180, in combination with additional circuitry such as a buffer memory (not shown) and baseband circuit 1156, may function to perform the methods previously described. Alternatively or in addition, baseband processing circuit 1156 may perform these processes independent of MAC processing circuit 1159. MAC and PHY processing may also be integrated into a single circuit if desired.

Apparatus 1100 may be, for example, a base station, an access point, an eNodeB, a hybrid coordinator, a wireless router or alternatively a fixed or mobile user station such as a UE, platform or terminal, including a or NIC and/or network adaptor for computing devices. Accordingly, the previously described functions and/or specific configurations of apparatus 1100 could be included or omitted as suitably desired.

Embodiments of apparatus 1100 may also be implemented using SISO, MISO, or SIMO architectures. However, as shown in FIG. 11, certain preferred implementations may include multiple antennas (e.g., 1118, 1119) for transmission and/or reception using spatial multiplexing, spatial division multiple access (SDMA), beamforming and/or multiple input multiple output (MIMO) communication techniques. Further, embodiments of the invention may utilize multi-carrier code division multiplexing (MC-CDMA) multi-carrier direct sequence code division multiplexing (MC-DS-CDMA) or single carrier modulation techniques for OTA link access or any other modulation or multiplexing scheme compatible with the features of the inventive embodiments.

The following clauses pertain to further embodiments. An apparatus 1100 is arranged to deploy a PCell in a wireless network comprising a PCell and a secondary cell SCell, the apparatus 1100 comprising processing circuitry 1150 arranged to allocate PUCCH resources using a PDSCH in the PCell, wherein the apparatus is further arranged to indicate PUCCH resources to a UE such as UE3 124 using a first or lowest control channel element index over a PDCCH of the PCell and wherein between two and four subframes are used to indicate the PUCCH resources. The apparatus 1100 can further comprise a radio interface 1110 arranged to transmit a plurality of DL subframes to the PCell. The apparatus 1100 may be part of an eNodeB, such as the eNodeB1 114 arranged to communicate with another eNodeB, such as eNodeB2 116, to deploy two serving cells to allocate PUCCH resources to the UE.

Further, the apparatus 1100 can provide PUCCH resource allocation by transmitting DL subframes to the UE in a PDSCH, wherein the PDSCH is indicated by detection of a PDCCH by a UE on a PCell, and wherein the PUCCH resources are indicated using a first control channel element index of the PDCCH. The UE can be served by the PCell and a SCell. Further, the PDSCH may be scheduled on the SCell by the PCell using cross-carrier scheduling. Between two and four DL subframes may be used to indicate the first control channel element index of the PDCCH. Further, the apparatus may be arranged to operate in compliance with 3GPP LTE-A Release 10.

Additionally, the apparatus 1100, which may be part of an eNodeB, can provide PUCCH resource allocation by transmitting DL subframes to a UE in a PDSCH of a SCell, wherein the PDSCH is indicated by detection of a PDCCH by the UE on the SCell, and wherein the PUCCH resources are indicated using a field in DCI transmitted on the PDCCH. The PUCCH resources may be allocated to the UE for use over a PCell. In other embodiments, the PUCCH resources may be implicitly indicated by detecting a PDCCH over the PCell. Further, the UE may be served by the PCell and the SCell using two component carriers. Also, the field may be a TPC field in the DCI corresponding to a PDCCH in the DL SCell within three DL subframes, as the ACK/NAK resource indicator bits, wherein the TPC field may be used to explicitly indicate a PUCCH resource, and wherein the PUCCH resource is configured by a higher layer such as through radio resource control (RRC) signaling.

The apparatus 1100 can also be arranged for wireless communication in a primary cell (PCell) and a secondary cell (SCell), wherein the PCell and the SCell are arranged as serving cells for the apparatus, of a time division duplexing (TDD) wireless network, such as the wireless communication network 100 of FIG. 1. The apparatus 1100 can comprise processing circuitry 1150 arranged to determine PUCCH resource allocation from PDSCH(s) in the wireless network, wherein the PUCCH resources are derived from two or more PDSCH subframe transmissions on the PCell and the SCell. The PUCCH in this embodiment may be used to feedback HARQ-ACK information to an eNodeB such as the eNodeB1 114. Two to four PUCCH resources can be associated with the PDSCH subframe transmissions. Further the PUCCH resources are associated with an uplink (UL) subframe, wherein the PUCCH resources indicated or derived by the apparatus implicitly and/or explicitly are provided to the apparatus for UL signaling in one UL subframe. Additional subframes may be provided in other embodiments. In this embodiment, each PUCCH resource is associated with a subframe transmitted on the PDSCH. Additionally, at least one of the PUCCH resources can be indicated using a field in downlink control information transmitted on a PDCCH of the SCell, wherein the field in the downlink control information is a transmit power control (TPC) field. Further, in this embodiment, the apparatus can be part of a UE, mobile station, or terminal.

An apparatus 1100 for wireless communication in a time division duplexing (TDD) wireless network comprising a primary cell (PCell) and a secondary cell (SCell) such as the wireless communication network 100 of FIG. 1. The apparatus 1100 can comprise processing circuitry 1150 arranged to allocate PUCCH resources using a PDSCH in the wireless network 100, the PUCCH resources to be derived by a UE from one or more PDSCH subframe transmissions on the PCell and the SCell. Two to four PUCCH resources can be associated with the PDSCH subframe transmissions, wherein the PUCCH resources are associated with an uplink (UL) subframe on the PUCCH. The UL subframe may be in the same frame as the PDSCH subframe transmissions, or a following frame. In an embodiment, each PUCCH resource is associated with a subframe transmitted on the PDSCH.

The components and features of apparatus 1100 may be implemented using any combination of discrete circuitry, application specific integrated circuits (ASICs), logic gates and/or single chip architectures. Further, the features of apparatus 1100 may be implemented using microcontrollers, programmable logic arrays and/or microprocessors or any combination of the foregoing where suitably appropriate. It is noted that hardware, firmware and/or software elements may be collectively or individually referred to as “logic” or “circuit”.

It should be appreciated that the example apparatus 1100 shown in the block diagram of FIG. 11 represents only one functionally descriptive example of many potential implementations that may be combined with memory device(s), processor(s), an interface such as a display and/or touchscreen, a keyboard, and/or communication port(s). Accordingly, division, omission or inclusion of block functions depicted in the accompanying figures does not infer that the hardware components, circuits, software and/or elements for implementing these functions would be necessarily be divided, omitted, or included in embodiments of the present invention.

Unless contrary to physical possibility, the inventors envision the methods described herein: (i) may be performed in any sequence and/or in any combination; and (ii) the components of respective embodiments may be combined in any manner.

Embodiments of the invention may include sets of instructions executed on some form of processing core or otherwise implemented or realized upon or within a machine-readable medium. A machine-readable medium includes any mechanism for storing or transmitting information in a tangible form readable by a machine (e.g., a computer). For example, a machine-readable medium can include an article of manufacture such as a read only memory (ROM); a random access memory (RAM); a magnetic disk storage media; an optical storage media; and a flash memory device, etc. In addition, a machine-readable medium may include propagated signals such as electrical, optical, acoustical or other form of propagated signals (e.g., carrier waves, infrared signals, digital signals, etc.).

Although there have been described example embodiments of this novel invention, many variations and modifications are possible without departing from the scope of the invention. Accordingly the inventive embodiments are not limited by the specific disclosure above, but rather only by the scope of the appended claims and their legal equivalents.

The invention claimed is:

1. A method comprising:
receiving one or more synchronization signals from a primary cell (PCell);
receiving an activation command for a secondary cell (SCell);
receiving, in one or more control channel elements (CCEs), a physical downlink control channel (PDCCH) transmission to indicate a physical downlink shared channel (PDSCH) transmission on the SCell; and
determining an allocation of a physical uplink control channel (PUCCH) resource based on a first CCE of the one or more CCEs.

2. The method of claim 1, wherein the PDCCH transmission is a first PDCCH transmission, the PUCCH resource is a first PUCCH resource, and the method further comprises:
receiving, in at least one CCE, a second PDCCH transmission on the SCell, wherein the second PDCCH transmission includes downlink control information having a transmit power control (TPC) field; and
determining an allocation of a second PUCCH resource based on the TPC field.

3. The method of claim 1, wherein the PDSCH transmission is a first PDSCH transmission and the PUCCH resource is an uplink subframe that is to include hybrid automatic repeat request (HARQ) acknowledgment information for the first PDSCH transmission and a second PDSCH transmission on the PCell.

4. The method of claim 1, wherein said determining the allocation comprises:
determining the allocation of the PUCCH resource based on an index of the first CCE.

5. The method of claim 4, wherein the one or more CCEs comprise a plurality of CCEs having associated indices, and the index of the first CCE is a lowest of the indices associated with the plurality of CCEs.

6. The method of claim 1, wherein the PUCCH resource is provided for feedback of time division duplexing (TDD) hybrid automatic repeat request (HARQ) acknowledgement (ACK) information.

7. The method of claim 1, wherein the PUCCH resource is provided for uplink scheduling requests.

8. The method of claim 1, wherein the PUCCH resource is in an uplink subframe and the method further comprises:
transmitting, in the uplink subframe, time division duplexing (TDD) hybrid automatic repeat request (HARQ) acknowledgement (ACK) information for PDSCH transmissions in either two, three, or four downlink subframes.

9. The method of claim 8, wherein the TDD HARQ ACK information includes information for PDSCH transmissions in four downlink subframes and the method further comprises:
receiving PDCCH transmissions in each of the four downlink subframes; and
determining an allocation of four PUCCH resources in the uplink subframe based on the PDCCH transmissions received in each of the four downlink subframes.

10. The method of claim 1, wherein the PUCCH resource is a first PUCCH resource, the PDCCH transmission is a first PDCCH transmission received in a downlink subframe and the method further comprises:
receiving a second PDCCH transmission on the PCell in the downlink subframe to schedule a PDSCH transmission on the PCell; and
determining an allocation of a second PUCCH resource based on the second PDCCH transmission.

11. The method of claim 1, wherein the method is performed in compliance with 3rd Generation Partnership Project (3GPP) Release 10 Long Term Evolution Advanced (LTE-A).

12. The method of claim 1, wherein the PUCCH resource has a format 1b with channel selection.

13. The method of claim 1, wherein the PDCCH transmission is on the PCell.

14. A user equipment (UE) comprising:
receiving means to receive a downlink frame in a physical downlink shared channel (PDSCH) of a secondary cell (SCell) as indicated by detection of a physical downlink control channel (PDCCH) on the SCell;
scheduling means to determine an indication of a physical uplink control channel (PUCCH) resource using a field in downlink control information transmitted on the PDCCH; and
transmitting means to transmit, in the PUCCH resource, hybrid automatic request (HARQ) acknowledgement (ACK) information.

15. The UE of claim 14, wherein another PUCCH resource is indicated using a primary cell (PCell).

16. The UE of claim 15, wherein the PUCCH resource is explicitly indicated on the SCell and the other PUCCH resource is implicitly indicated on the PCell.

17. An apparatus for use in a wireless network, the apparatus comprising:
processing circuitry to determine a physical uplink control channel (PUCCH) resource allocation from a physical downlink control channel (PDCCH) that indicates a physical downlink shared channel (PDSCH) of a secondary cell (SCell),
wherein two to four PUCCH resources are to be implicitly indicated by one or more PDCCH transmissions on a primary cell (PCell) or the SCell.

18. The apparatus of claim 17, further comprising a radio interface, wherein the radio interface is to receive downlink subframes from the PCell and SCell.

19. The apparatus of claim 18, wherein the apparatus is part of a user equipment (UE) that is to operate using orthogonal frequency division multiple access (OFDMA) in downlink and single-carrier frequency division multiple access (SC-FDMA) in uplink communications.

20. The apparatus of claim 17, wherein the apparatus is to determine a first PUCCH resource of the two to four PUCCH resources using a transport control power field in downlink control information of a PDCCH transmission on the SCell.

21. The apparatus as recited in claim 17, wherein the apparatus is to determine a first PUCCH resource of the two to four PUCCH resources using a first control channel element (CCE) index of a PDCCH transmission on the PCell.

22. The apparatus of claim 17, wherein the user equipment (UE) comprises a touchscreen user interface.

23. An apparatus for use in a wireless network comprising a primary cell (PCell) and a secondary cell (SCell), the apparatus comprising:
processing circuitry to allocate, for transmission of hybrid automatic repeat request (HARQ) acknowledgement (ACK) information, one or more physical uplink control channel (PUCCH) resources of an uplink subframe using one or more physical downlink control channel (PDCCH) transmissions in the PCell or SCell,
wherein the apparatus is to indicate a first PUCCH resource of the one or more PUCCH resources using an index of a control channel element carrying a first PDCCH transmission of the one or more PDCCH transmissions, and between two and four downlink subframes are to be used to indicate the allocated PUCCH resources of the uplink subframe.

24. The apparatus of claim 23, wherein the first PDCCH transmission is to be transmitted in a first downlink subframe and the apparatus is to indicate a second PUCCH resource of the plurality of PUCCH resources using a second PDCCH transmission of the first downlink subframe.

25. The apparatus of claim 23, wherein the control channel element (CCE) is a first CCE, and the apparatus is to indicate a second PUCCH resource of the plurality of PUCCH resources using an index of a second CCE carrying the first PDCCH transmission.

26. The apparatus of claim 23, wherein the one or more PDCCH transmissions are in both the PCell and the SCell.

27. The apparatus of claim 26, wherein at least one of the PUCCH resources is explicitly indicated using a field in downlink control information transmitted in a PDCCH transmission of the SCell.

28. An apparatus for use in a wireless network comprising a primary cell (PCell) and a secondary cell (SCell), the apparatus comprising:
processing circuitry to allocate physical uplink control channel (PUCCH) resources,
wherein the apparatus is to explicitly indicate at least one of the PUCCH resources using a field in downlink control information transmitted on a physical downlink control channel (PDCCH) transmission of the SCell.

29. The apparatus of claim 28, wherein the apparatus is allocate the PUCCH resources for a user equipment (UE) to send hybrid automatic repeat request (HARQ) acknowledgement (ACK) information and uplink scheduling requests to the apparatus.

30. The apparatus of claim 28, wherein the field in the downlink control information is a transmit power control (TPC) field.
